(19) United States
(12) Patent Application Publication
(10) Pub. No.: US 2010/0296270 A1
(43) Pub. Date: Nov. 25, 2010

(54) DISPLAY DEVICE AND LIGHT EMITTING DEVICE

(75) Inventors: Shuji Gomi, Chiba (JP); Kenji Shinozaki, Chiba (JP)

Correspondence Address: SUGHRUE MION, PLLC, 2100 PENNSYLVANIA AVENUE, N.W., SUITE 800, WASHINGTON, DC, 20037, US

(73) Assignee: SHOWA DENKO K.K., Minato-ku, Tokyo (JP)

(21) Appl. No.: 12/864,458

(22) PCT Filed: Jan. 21, 2009
(86) PCT No.: PCT/JP2009/050795

§ 371 Date: Jul. 23, 2010

(30) Foreign Application Priority Data
Jan. 25, 2008 (JP) 2008-015492

(51) Int. Cl. G02F 1/13357

(52) U.S. Cl. 362/97.3

(57) ABSTRACT

Reflectors (50) are a member subjected to mirror reflection processing, and are arranged on a light irradiation side of a light source module (31). Each of the reflectors (50) includes a horizontal reflection portion (51) provided along a rear face portion of a backlight frame and a slant reflection portion (52) having a predetermined angle with respect to the horizontal reflection portion (51). In this manner, the horizontal reflection portion (51) is arranged in an area which is near the light source and has a high light intensity, while the slant reflection portion (52) is arranged in an area which is farther from the light source and has a low light intensity, so that uniformity in light reflection amount may be achieved and occurrence of luminance variation is suppressed. Further, provision of a light guide plate, for example, is unnecessary, and thus thickness reduction and weight reduction of the device may be achieved. Thereby, a light emitting device and a display device having high luminance and contributing thickness reduction and weight reduction are provided. Further, in a light emitting device using solid-state light emitting elements, such as LEDs, luminance variation is suppressed to achieve uniformity in the luminance.

### TECHNICAL FIELD

The present invention relates to a display device and a light emitting device using solid-state light emitting elements.

### BACKGROUND ART

Display devices such as liquid crystal display devices, typified by a liquid crystal display television, a liquid crystal display monitor and the like, have adopted a backlight as a light emitting device for emitting light from the back of a display panel. A fluorescent tube such as a hot-cathode fluorescent tube or a cold-cathode fluorescent tube is widely used as the above-mentioned backlight device. On the other hand, technologies of backlight devices using light emitting diodes (LEDs), with which downsizing and power saving of the device are expected, as a light source, have been recently developed as a substitute for the backlight devices using the fluorescent tubes.

As the backlight using light emitting diodes (LEDs), there is a so-called direct-lighting type in which a light source is disposed on a plane surface beneath the liquid crystal panel (a rear surface), for example (see Patent Document 1, for example). On the other hand, there is a so-called edge-lighting type in which a light source is disposed on two or one side of a light guide plate made of transparent resin, so that light incident on the light guide plate is reflected by a reflector provided on the back surface of the light guide plate, thereby to illuminate, for example, the surface of a liquid crystal display panel (see Patent Document 2, for example).

Patent Document 1: Japanese Patent Application Laid Open Publication No. 2007-305341

Patent Document 2: Japanese Patent Application Laid Open Publication No. 6-3527

### DISCLOSURE OF THE INVENTION

### Problems to be Solved by the Invention

A backlight of the direct-lighting type has an advantage of ensuring high luminance. However, luminance variation is likely to occur because the backlight has higher luminance directly above a portion where a light source is arranged as compared with the periphery thereof. Additionally, in particular, in a case where multi-color light emitting diodes (LEDs), such as RGB, rather than monochromatic light emitting diodes are used for color mixing, it is necessary that light emitted from these multi-color light emitting diodes is sufficiently mixed, and then illuminates a liquid crystal display panel or the like, for example. Thus, it is necessary to ensure a length of an optical path from the light source to an irradiated object, such as the liquid crystal display panel, in order to improve color mixing. Accordingly, the backlight of the direct-lighting type has a large thickness of the device itself.

Even for the backlight of the direct-lighting type, the thinner design of the backlight device is achieved by employing a configuration in which the light source emits light in a direction parallel to the liquid crystal display panel, for example. However, a light guide plate is generally required in order to irradiate the liquid crystal display panel with light emitted in this parallel direction. There has been a problem that the weight of the device increases when the light guide plate is included.

The present invention has been made in order to address the above technological problems. An object of the present invention is to provide a light emitting device and a display device that have high luminance and contribute thickness reduction and weight reduction.

Additionally, another object of the present invention is to provide a light emitting device using solid-state light emitting elements such as LEDs, the light emitting device being capable of reducing the luminance variation to achieve uniformity in the luminance.

### Means for Solving the Problems

In order to attain the above object, there is provided a display device including: a display panel that displays an image; and a light emitting device that includes one or plural light emitting units, that is provided behind the display panel, and that emits light from behind the display panel. Each of the light emitting units includes: plural solid-state light emitting elements; a shield portion formed to extend in a direction parallel to a principal surface of the display panel, at the display panel side of the plural solid-state light emitting elements; a first reflection portion that is extended in the direction parallel to the principal surface of the display panel, at an opposite side of the plural solid-state light emitting elements from the display panel, and that reflects light emitted from any of the plural solid-state light emitting elements; and a second reflection portion that is extended toward the display panel while having a predetermined angle with respect to the first reflection portion, and that reflects light emitted from any of the plural solid-state light emitting elements. Further, in a case where the plural light emitting units are provided, the plural light emitting units are arrayed adjacent to each other.

In addition, the plural solid-state light emitting elements provided to one of the light emitting units among the plural light emitting units arrayed adjacent to each other are arranged so as to be placed under the second reflection portion on an opposite side of the second reflection portion from the display panel, the second reflection portion being provided to a different light emitting unit adjacent to the one of the light emitting units. This is preferable because the light emitting surface is occupied by the first reflection portion and the second reflection portion and thus occurrence of luminance variation is suppressed.

The display device further includes: a mount board on which the plural solid-state light emitting elements are mounted; and a wiring board that is extended in the direction parallel to the principal surface of the display panel, and on which the mount board is arranged in such a manner that the wiring board is electrically connected to the mount board. The mount board has a first surface on which the plural solid-state light emitting elements are mounted, and is attached to the wiring board in such a manner that a second surface of the mount board is placed on the wiring board side, the second surface being orthogonal to the first surface.

Here, the display device further includes a connector that is electrically connected to the wiring board and that supplies power to the plural solid-state light emitting elements. The connector is provided so as to be placed under the second reflection portion on an opposite side of the second reflection portion from the display panel. This is preferable because additional provision of space to arrange a connector is not necessary and thus downsizing of the light emitting device or the like is achieved.

In another aspect of the present invention, there is provided a light emitting device including plural solid-state light emitting elements arrayed on a plane. The light emitting device includes: a frame having a plane portion; a board on which any of the plural solid-state light emitting elements are arrayed in a line; a shield portion formed to extend in a direction parallel to the plane portion of the frame, at an opposite side of the solid-state light emitting elements arrayed on the board from the frame; a first reflection portion that is extended in the direction parallel to the plane portion of the frame, at the frame side of the solid-state light emitting elements, and that reflects light emitted from the solid-state light emitting elements arrayed on the board; and a second reflection portion that is extended while having a predetermined angle with respect to the first reflection portion, and that reflects light emitted from the solid-state light emitting elements arrayed on the board.

Here, the predetermined angle is not less than 10 degrees but not more than 20 degrees. This is preferable because light emitted from plural solid-state light emitting elements is uniformly reflected toward the display panel, for example.

In addition, the first reflection portion includes: a first regular reflection portion that regularly reflects light from the solid-state light emitting elements; and a first diffusion-reflection portion that is formed to have a larger area at a position farther from the solid-state light emitting elements, and that diffusively reflects light from the solid-state light emitting elements. The second reflection portion includes: a second regular reflection portion that regularly reflects light from the solid-state light emitting elements; and a second diffusion-reflection portion that is formed to have a smaller area at a position farther from the solid-state light emitting elements, and that diffusively reflects light from the solid-state light emitting elements.

Furthermore, the light emitting device further includes an absorbing member that is provided on the solid-state light emitting elements side of the first reflection portion, and that absorbs part of light from the solid-state light emitting elements. This is preferable because an amount of reflected light near the solid-state light emitting elements having large light intensity is suppressed.

### ADVANTAGES OF THE INVENTION

According to the present invention, it is possible to provide a light emitting device and a display device that have high luminance and achieve thickness reduction and weight reduction.

### BEST MODES FOR CARRYING OUT THE INVENTION

Hereinafter, an exemplary embodiment of the present invention will be described with reference to the accompanying drawings.

### Exemplary Embodiment 1

FIG. 1 is a view showing an entire configuration of a liquid crystal display device to which the present exemplary embodiment is applied. Note that, FIG. 1 shows a state where reflectors 50 to be described later are not mounted. Also, in FIG. 1, a vertical direction V and a horizontal direction H of the liquid crystal display device are shown with arrows.

The liquid crystal display device to which the present exemplary embodiment is applied includes: a liquid crystal display module 20; and a backlight device (backlight) 10 provided on a back side (a lower side in FIG. 1) of the liquid crystal display module 20.

The backlight device 10, serving as a light emitting device, includes: a backlight frame (frame) 11 that equips with a light source; and light emitting units 30 that each include multiple light emitting diodes (referred to as LEDs in the following description) as solid-state light emitting elements. In an example shown in FIG. 1, the multiple light emitting units 30 are arrayed in the backlight frame 11. The LEDs provided to the light emitting units 30 are arranged so that an optical axis thereof is formed in a direction parallel to a principal surface of an irradiated body (the liquid crystal display module 20 in this example).

Additionally, as a laminate of optical films, the backlight device 10 includes: a diffusion plate 12 (plate or film) that is made of resin having light permeability for visible light, and scatters and diffuses light for obtaining uniform lightness on the entire plane; and prism sheets 13 and 14 formed of diffraction grating films having a light focusing function toward the front side. In addition, the backlight device 10 includes, as necessary, a luminance enhancement film 15 with diffusion and reflection type for improving luminance. Note that the backlight device 10 to which the present exemplary embodiment is applied does not include a so-called light guide plate (light guide).

On the other hand, the liquid crystal display module 20 includes: a liquid crystal panel 21, as a display panel, composed of two glass substrates with liquid crystal interposed therebetween; and polarization plates 22 and 23 stacked on the respective glass substrates of the liquid crystal panel 21 for restricting the oscillation of optical wave to a given direction. Further, to the liquid crystal display module 20, peripheral members such as an unillustrated LSI for driving are equipped.

The liquid crystal panel 21 includes various unillustrated components. For example, the two glass substrates have unillustrated display electrodes, active elements such as a thin film transistor (TFT: thin film transistor), liquid crystal, spacer, sealant, an orientation film, a common electrode, a protective film, a color filter and the like.

Note that the structural unit of the backlight device 10 may be selected in an arbitrary way. For example, the unit of the backlight frame 11 including the light emitting units 30 therein may be called as a “backlight device (backlight)” and distributed as a service unit not including the diffusion plate 12, the prism sheets 13 and 14 and the luminance enhancement film 15.

FIG. 2 is a view for explaining a part of the structure of the backlight device 10 to which the present exemplary embodiment is applied.

The backlight frame 11 has a housing structure made of, for example, aluminum, magnesium, iron or a metallic alloy including at least one of these materials. The housing structure is composed of a back surface portion corresponding to the size of the liquid crystal display module 20 (see FIG. 1) and side surface portions enclosing the four corners of the back surface portion. The side surface portions inside of the housing structure include a polyester film or the like having a high performance of reflecting white light, for example, adhered thereto so as to function as a reflector. In addition, on the back surface portion or the side surface portions, a heat sink configuration including a cooling fin and the like for exhausting heat may be provided as necessary.

As shown in FIG. 2, each of the light emitting units 30 includes: a light source module 31; and the reflector 50 that reflects light emitted by the light source module 31 toward the liquid crystal display module 20. In an example shown in FIG. 2, a total of eight light emitting units 30, which are four columns in the vertical direction V and two rows in the horizontal direction H, are provided. Each of the light emitting units 30 is fixed to the backlight frame 11 with screws, adhesive or the like (not shown).

Also, in the present exemplary embodiment, light emission control is performed for each of the light emitting units 30, so that the following so-called area control is allowed to be performed. For example, when an image is displayed on the liquid crystal display device, some of the light emitting units 30 located on the back surface side at positions where the displayed image is black are put out.

FIG. 3A shows an overall view of the light source module 31. FIG. 3B is a view of a light emitting portion 310 viewed from a light emitting surface side. FIG. 3C is a view of the light emitting portion 310 viewed from an opposite side from the light emitting surface. FIG. 3D is a cross-sectional view taken along the A-A line in FIG. 3A. Note that FIG. 3A provides illustration in which a shield member 45 to be described later is omitted.

As shown in FIGS. 3A and 3D, the light source module 31 includes: the light emitting portions 310 each having three LEDs 34; a wiring board 36 to which the multiple light emitting portions 310 are attached; and the shield member 45. The wiring board 36 has: electrical paths through which power is supplied to the LEDs 34 provided to each of the multiple light emitting portions 310; and heat discharge paths through which heat generated from the LEDs 34, followed by the power supply, escapes.

As shown in FIG. 3B, each of the light emitting portions 310 has: a plate-shaped board 32 as a mount board; and a red LED 34R, a green LED 34G and a blue LED 34B as the three LEDs 34 mounted on the plate-shaped board 32.

The plate-shaped board 32 has a rectangular shape in this example, and a so-called glass epoxy substrate whose glass fibers are impregnated with epoxy resin or the like may be used as a base material of the plate-shaped board 32. In addition, on a first face (hereinafter, referred to as a mount face 32a) of the plate-shaped board 32, a power receiving pad and a die pad (not shown) are provided for each color LED 34, the mount face 32a being a side where the LEDs 34 are mounted. Meanwhile, when the plate-shaped board 32 is mounted on the wiring board 36, a second face (hereinafter, referred to as a contact face 32b) which is orthogonal and adjacent to the first face is placed on the wiring board 36 side. Each color LED 34 is thermally attached onto the die pad with a die bonding agent such as silver paste, for example, and further is electrically connected to the power receiving pad with a bonding wire or the like.

In contrast, as shown in FIG. 3C, on an opposite side (hereinafter, referred to as a non-mount face 32c) of the plate-shaped board 32 from the mount face 32a, a power supply pad 40 and a heat discharge pad 41 are provided for each color LED 34. In addition, the power supply pad 40 provided on the non-mount face 32c and the power receiving pad formed on the mount face 32a are electrically connected to each other with a metal through-hole formed by penetrating the plate-shaped board 32. Similarly, the heat discharge pad 41 provided on the non-mount face 32c and the die pad formed on the mount face 32a are thermally connected to each other with a metal through-hole. Furthermore, each color LED 34 is encapsulated by seal resin 35. Here, the directivity of light may be enhanced by forming the seal resin 35 into a cannonball shape.

Subsequently, the wiring board 36 is described with reference to FIGS. 3A and 3D. As described above, the wiring board 36 is a printed wiring plate in which the power supply paths and the heat discharge paths for the multiple light emitting portions 310 are formed. As shown in FIG. 3A, the multiple light emitting portions 310 are attached to the wiring board 36 in a line in a longitudinal direction of the wiring board 36, facing in the same direction. Note that, a flexible printed circuit board (FPC) which is relatively thin is used for the wiring board 36 to which the present exemplary embodiment is applied. However, a glass epoxy substrate, a build-up substrate or the like may be used as in the plate-shaped board 32.

An electrical wiring pattern 37 (see FIG. 3D) which supplies power to each light emitting portion 310 (each color LED 34) is formed in a surface (hereinafter, referred to as a front surface), of the wiring board 36, on a side to which the light emitting portions 310 are attached. In addition, a heat discharge pattern 38 which discharges heat generated from each LED 34 is formed in a surface (hereinafter, referred to as a back surface), of the wiring board 36, on a side opposite to the side on which the light emitting portions 310 are attached. Note that, in order to exert the heat discharge effect to the maximum, the heat discharge pattern 38 is preferably formed in as large area as possible in the surface of the wiring board 36. Heat from the light emitting portion 310 is discharged from the front surface side of the wiring board 36 toward the heat discharge pattern 38 formed on the back surface side of the wiring board 36 via the heat discharge path such as a metal through-hole.

The light emitting portion 310 is attached to the wiring board 36 in such a manner that the contact face 32b substantially orthogonal to the mount face 32a is placed on the wiring board 36 side. In other words, the light emitting portion 310 is attached to the wiring board 36 in a state where a side face (the contact face 32b) forming the plate-shaped board 32 comes in contact with the wiring board 36 and thus the plate-shaped board 32 is upright. At this time, the power supply pad 40 provided for each color LED 34 and the electrical wiring pattern 37 formed in the wiring board 36 are electrically connected to each other by soldering. Similarly, the heat discharge pad 41 provided for each color LED 34 and the heat discharge path (heat discharge pattern 38) extracted to the front surface of the wiring board 36 are thermally connected to each other by soldering. Note that connection of the wiring board 36 and the plate-shaped board 32 by soldering also leads to mechanical connection thereof.

As described above, the plate-shaped board 32 is attached to the wiring board 36 being upright, and thereby the optical axis (an arrow shown in FIG. 3D) of the light emitting portion 310 extends in a direction parallel to the surface of the wiring board 36.

As shown in FIGS. 3A and 3D, connectors 39 each electrically connected to the electrical wiring pattern 37 are attached to the wiring board 36. Here, each of the connectors 39 is provided on an edge face in a direction opposite to a direction of emitting light from the light emitting portions 310 on the wiring board 36. The light emitting portions 310 receive power supplied from a power supply via the connector 39.

Next, a description is given of the shield member 45 provided on the light source module 31.

The shield member 45 is a rectangular plate member (see FIG. 4 to be described later), and uses a material having a light transmittance of about 10% or less. In addition, a regular reflection or a diffusion-reflection surface is formed on a surface of the shield member 45. As shown in FIG. 3D, the shield member 45 is attached to the liquid crystal display module 20 side of the plate-shaped board 32, while being supported by a support member 46 provided on the non-mount face 32c side (see FIG. 3C) of the plate-shaped board 32. In other words, the shield member 45 is attached, like eaves, to the multiple light emitting portions 310 arranged in a line. A width W of the eaves (the width W of a protruding portion of the shield member 45 (FIG. 3D)) is preferably formed up to at least the height of the seal resin 35 from the mount face 32a.

The width W of the protruding portion causes the shield member 45 to shield part of light heading for the liquid crystal display module 20 side out of light emitted from the light emitting portions 310. Provision of the shield member 45 described above inhibits the luminance near the light source module 31 on the light emitting surface of the backlight device 10, for example, from increasing in a hot-spot-like manner.

Next, the reflector 50 is described with reference to FIGS. 4 and 5.

FIG. 4 is a view for explaining the reflector 50. FIG. 5 is a view for explaining a horizontal reflection portion 51 and a slant reflection portion. Here, FIG. 5A is a cross-sectional view taken along the B-B line of the light emitting unit 30 shown in FIG. 4, and FIG. 5B is a view of the reflector 50 viewed from above in FIG. 5A.

As shown in FIG. 4, the reflector 50 is provided on the light irradiation side of the light source module 31. The reflector 50 is a member which uses a resin such as, for example, plastic as a base material and whose surface is subjected to regular-reflection (mirror reflection) processing using an evaporated silver film or the like, and, for example, LUIREMIRROR by Reiko Co., Ltd. is usable.

After being attached to the backlight frame 11, the reflector 50 includes the horizontal reflection portion 51 (see FIG. 5A) provided along a rear face portion of the backlight frame 11, and the slant reflection portion 52 having a predetermined angle with respect to the horizontal reflection portion 51. The horizontal reflection portion 51 is extended in a direction parallel to a plane portion of the backlight frame 11 (in a direction parallel to a principal surface of the liquid crystal panel 21), on the backlight frame 11 side of the LEDs 34 (light emitting portions 310), and functions as a first reflection portion which reflects light emitted from the LEDs 34 (light emitting portions 310) arranged on the wiring board 36. The slant reflection portion 52 functions as a second reflection portion extended so as to have a predetermined angle with respect to the horizontal reflection portion 51, which is the first reflection portion.

As shown in FIG. 4, the horizontal reflection portion 51 as the first reflection portion is a plate-shaped member provided in a longitudinal direction of the light source module 31. The length in a longitudinal direction of the horizontal reflection portion 51 to which the present exemplary embodiment is applied is set to be, for example, 375 mm. The horizontal reflection portion 51 is provided below the multiple LEDs 34 (on the backlight frame 11 side thereof) provided in the multiple light emitting portions 310 arranged in a line. A side surface of the horizontal reflection portion 51 is attached to the mount face 32a of the plate-shaped board 32 so as to come into contact with the mount face 32a. Note that a recess (not shown) is provided beforehand in a surface on the backlight frame 11 side of the horizontal reflection portion 51, at a position in which the horizontal reflection portion 51 comes into contact with the wiring board 36. This inhibits the attachment accuracy of the horizontal reflection portion 51 from lowering due to the thickness of the wiring board 36.

As shown in FIG. 4, an absorbing member 56 which absorbs part of the light emitted from the light emitting portions 310 is provided on the light source module 31 side of the horizontal reflection portion 51 so as to have a predetermined width C (about 8 mm in this example). In the present exemplary embodiment, the absorbing member 56 is formed by printing black ink on the light source module 31 side of the horizontal reflection portion 51. Note that mono-tone paper such as Kent paper, woodfree paper and wood containing paper may also be used as the absorbing member 56.

The provision of the absorbing member 56 on the light source module 31 side of the horizontal reflection portion 51 suppresses light reflection near the light source module 31, which has a high light intensity, thus suppressing occurrence of luminance variation attributable to an extremely increased amount of light reflection in this region.

The length, of the slant reflection portion 52 as the second reflection portion, in a longitudinal direction thereof is set to be, for example, 375 mm, as in the horizontal reflection portion 51. One side, of the slant reflection portion 52, in the longitudinal direction is connected to the horizontal reflection portion 51 on the side farther from the light source module 31, while the other side thereof is fixed in an abrupt manner. In other words, the reflection surface of the slant reflection portion 52 is provided obliquely with respect to the light emitting surface of the light source module 31.

As described above, the horizontal reflection portion 51 and the slant reflection portion 52 are arranged in order of the light source module 31, the horizontal reflection portion 51 and the slant reflection portion 52, in the direction of emitting light by the light source module 31.

As shown in FIG. 5A, the reflector 50 to which the present exemplary embodiment is applied is set so that a width L1′ of the horizontal reflection portion 51 in a light irradiation direction should be about 50 mm and a width L2 of the slant reflection portion 52 should be about 70 mm. Note that, since the absorbing member 56 is provided on the horizontal reflection portion 51 as described above, the net width L1 (=L1′−C) of the reflection surface of the horizontal reflection portion 51 is about 42 mm. In this manner, the reflector 50 is set to have a ratio of the width L1 of a reflection surface of the horizontal reflection portion 51 to the width L2 of the reflection surface of the slant reflection portion 52 which is approximately 3 to 5, the widths being in the light irradiation direction.

Also, as shown in FIG. 5A, the reflector 50 to which the present exemplary embodiment is applied is set to have an angle•of about 15 degrees, the angle•being made between a surface formed by the slant reflection portion 52 and a surface formed by the horizontal reflection portion 51. The angle•is preferably not less than 10 degrees but not more than 20 degrees.

Furthermore, as shown in FIG. 5B, the reflector 50 to which the present exemplary embodiment is applied is provided with a first diffusion-reflection portion 51a on the horizontal reflection portion 51 and a second diffusion-reflection portion 52a on the slant reflection portion 52.

The first diffusion-reflection portion 51a and the second diffusion-reflection portion 52a have a function of diffusion reflection (irregular reflection) of the light emitted from the light source module 31 (light emitting portions 310) and each include multiple dots 55. The dots 55 are formed, for example, by printing white ink substantially circularly on the surface of the reflector 50.

When the number of the dots 55 provided in the longitudinal direction of the horizontal reflection portion 51 is fixed, the size (area) of the dots 55 forming the first diffusion-reflection portion 51a is set to be gradually increased with the increase of the distance between the dots 55 and the light emitting portions 310 (mount face 32a) which is the light source. In contrast, when the number of the dots 55 provided in the longitudinal direction of the slant reflection portion 52 is fixed, the size (area) of the dots 55 forming the second diffusion-reflection portion 52a is set to be gradually decreased with the increase of the distance between the dots 55 and the light emitting portions 310 (mount face 32a) which is the light source.

In addition, when the size (area) of the dots 55 forming the first diffusion-reflection portion 51a is fixed, the number of the dots 55 formed in the horizontal reflection portion 51 may be set to be gradually decreased with the increase of the distance between the dots 55 and the light emitting portions 310. Likewise, when the size (area) of the dots 55 forming the second diffusion-reflection portion 52a is fixed, the number of the dots 55 formed in the slant reflection portion 52 may be set to be gradually increased with the increase of the distance between the dots 55 and the light emitting portions 310.

Note that the multiple dots 55 provided in the horizontal reflection portion 51 function as the first diffusion-reflection portion, while a surface excluding the dots 55 in the horizontal reflection portion 51 functions as a first regular reflection portion. Also, the multiple dots 55 provided in the slant reflection portion 52 function as the second diffusion-reflection portion, while a surface excluding the dots 55 in the slant reflection portion 52 functions as a second regular reflection portion.

FIG. 6 is a view for explaining a state in which the multiple light emitting units 30 are attached to the backlight frame 11.

The multiple light emitting units 30 configured as described above are attached to the backlight frame 11 (see FIG. 2). Here, as shown in FIG. 6, in each of the light emitting units 30, the light source module 31 provided to the light emitting unit 30 is provided so as to be placed under the slant reflection portion 52 (on an opposite side from the liquid crystal panel 21 side) provided to another light emitting unit 30 provided adjacently. In addition, being aligned with the light source module 31, the slant reflection portion 52 is attached so as to cover the light source module 31 (on the liquid crystal panel 21 side).

Note that, in order to fix the slant reflection portion 52, a pole 53 may be used to support the slant reflection portion 52 as shown in FIG. 6, when the light emitting units 30 are attached to the backlight frame 11.

When the backlight device 10 is viewed from above (from the liquid crystal panel 21 side) with the multiple light emitting units 30 attached to the backlight frame 11, the reflection surfaces of the horizontal reflection portion 51 and the slant reflection portion 52 of the reflector 50 occupy a surface of the backlight frame 11. Thereby, the light source module 31 is shaded, for example, on the side which is not irradiated with the light, but the shaded portion is covered with the slant reflection portion 52. This suppresses occurrence of luminance variation.

Meanwhile, as shown in FIG. 6, space having a triangle cross section is formed between the slant reflection portion 52 provided on each of the light emitting units 30 and the backlight frame 11. In the present exemplary embodiment, the aforementioned connectors 39 of the light source module 31 are arranged so as to be placed in this space formed under the slant reflection portion 52 (on the opposite side from the liquid crystal panel 21). This eliminates the need to provide space for providing the connectors 39, for example, in a side face portion or the rear face portion of the backlight frame 11, thus achieving reduction in size of the device.

Unlike the present exemplary embodiment described above, the wiring board 36 may be extended to the slant reflection portion 52 side in each light emitting unit 30, and the connectors 39 may be arranged so as to be placed under the slant reflection portion 52.

Meanwhile, as shown in FIG. 6, the heat discharge pattern 38 provided in the back surface of the wiring board 36 is attached to the backlight frame 11 in contact therewith. Accordingly, heat generated from each LED 34 is dischargeable further to the backlight frame 11 via the heat discharge pattern 38. Thereby, the heat is efficiently dischargeable.

Next, a description is given of a light emitting operation of the backlight device 10.

When a voltage is applied to the light source modules 31 by the power supply, a current flows to the red LED 34R, the green LED 34G and the blue LED 34B (see FIG. 3B) provided in each of the light emitting portions 310. Then, light of R (red), G (green) and B (blue) is emitted to the reflector 50 side from each color LED 34 in the light emitting portions 310. While proceeding inside the backlight frame 11, the RGB light emitted by the light emitting portions 310 is mixed to each other to turn into white light. The white light is reflected by the reflector 50, and proceeds to the diffusion plate 12 in this example (see FIG. 6). The white light is subjected to further color mixture acceleration by the diffusion plate 12, then transmits through the prism sheets 13 and 14 and the luminance enhancement film 15, and thereafter is emitted toward the liquid crystal display module 20.

Here, a description is given of a relationship between the light emitted by the light source module 31, and the horizontal reflection portion 51 and the slant reflection portion 52 in the reflector 50. As described above, part of the light emitted from the light emitting portions 310 is reflected by the horizontal reflection portion 51 or the slant reflection portion 52 to proceed to the diffusion plate 12.

From a viewpoint of light properties, an area near the light source module 31 (light emitting portions 310) has a higher light intensity, while an area farther from the light source module 31 has a lower light intensity. To cope with the light properties, as shown in FIG. 6, in the reflector 50 to which the present exemplary embodiment is applied, the horizontal reflection portion 51 is arranged in the area which is near the light source and has a high light intensity, and thereby an amount of light reflection to the liquid crystal display module 20 side becomes relatively small. In contrast, in the area which is farther from the light source and has a low light intensity, there is arranged the slant reflection portion 52 having an angle of not less than 10 degrees but not more than 20 degrees, preferably approximately 15 degrees, with respect to the horizontal reflection portion 51, and thereby the amount of light reflection to the liquid crystal display module 20 side becomes relatively large. This leads to achievement of uniformity in light reflection amount on the reflection surface, and thus suppression of occurrence of luminance variation.

Note that, when the angle of the slant reflection portion 52 with respect to the horizontal reflection portion 51 is larger than 20 degrees, the light reflection amount at a position, of the slant reflection portion 52, close to the light source module 31 is increased, and conversely, the light reflection amount at a position, of the slant reflection portion 52, farther from the light source module 31 is decreased. In contrast, when the angle of the slant reflection portion 52 with respect to the horizontal reflection portion 51 is smaller than 10 degrees, the light reflection amount in the slant reflection portion 52 falls short, and thus the entire area of the slant reflection portion 52 becomes dark. Accordingly, as described above, the angle of the slant reflection portion 52 with respect to the horizontal reflection portion 51 is preferably not less than 10 degrees but not more than 20 degrees.

In addition, in the backlight device 10 to which the present exemplary embodiment is applied, the slant reflection portion 52 has about five thirds the width of the horizontal reflection portion 51. Here, a description is given of the relationship between the width L1 of the reflection surface of the horizontal reflection portion 51 and the width L2 of the reflection surface of the slant reflection portion 52. For example, when L1/L2 is set smaller than three fifths, the light emitted from the light source module 31 does not reach an edge face of the slant reflection portion 52, and thus the edge face (the side farther from the light source) of the slant reflection portion 52 becomes dark. On the other hand, for example, when L1/L2 is set larger than about three fifths, reflection falls short at a position, of the horizontal reflection portion 51, farther from the light source module 31, and thus this portion becomes dark. Accordingly, L1/L2 is preferably about three fifths.

Furthermore, the first diffusion-reflection portion 51a is formed on the horizontal reflection portion 51 as described above. Thereby, for example, a region on the side, of the horizontal reflection portion 51, farther from the light source is irradiated with light proceeding straight from the light source and reflected light reflected by the shield member 45. However, this region is set to have a large area of diffusion reflection (irregular reflection) of light (see FIG. 5B), which inhibits a light reflection amount in this region from becoming remarkably large in comparison with other areas.

Meanwhile, the area of a regular reflection surface on the side, of the second diffusion-reflection portion 52a, farther from the light source is set large (see FIG. 5B), and thereby the light from the light source is allowed to be reflected without reducing the intensity of the light from the light source. Furthermore, this allows the diffusion plate 12 to reflect the light from the light source in a wide range as well as directly under the reflector 50.

As described above, the backlight device 10 to which the present exemplary embodiment is applied is capable of achieving uniformity of light amount in the entire light emitting surface, when the LEDs 34 are arranged in such a manner that the optical axis thereof is directed to the side of the backlight device 10 and even when a so-called light guide plate is not used. In addition, the backlight device 10 to which the present exemplary embodiment is applied does not use the light guide plate, thus being capable of achieving weight reduction of the device.

Note that in the present exemplary embodiment, the red LED 34R, the green LED 34G and the blue LED 34B are used to obtain RGB light from the light emitting portion 310. However, the configuration is not limited to this. For example, the RGB light may be obtained by combining the blue LED and a phosphor. Furthermore, in the present exemplary embodiment, the light emitting portion 310 includes the LEDs 34 for respective colors RGB. However, the light emitting portion 310 may be configured by providing, for example, four LEDs of RGGB or the like.

### BRIEF DESCRIPTION OF THE DRAWINGS

FIG. 1 is a view showing an entire configuration of a liquid crystal display device to which the exemplary embodiment is applied;

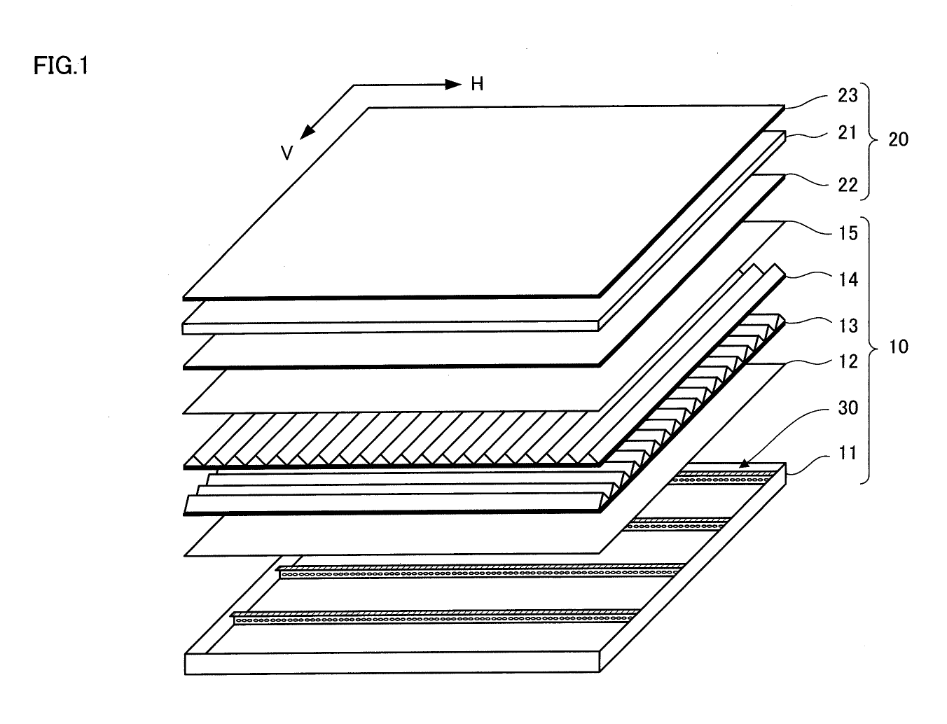

FIG. 2 is a view for explaining a part of the structure of the backlight device;

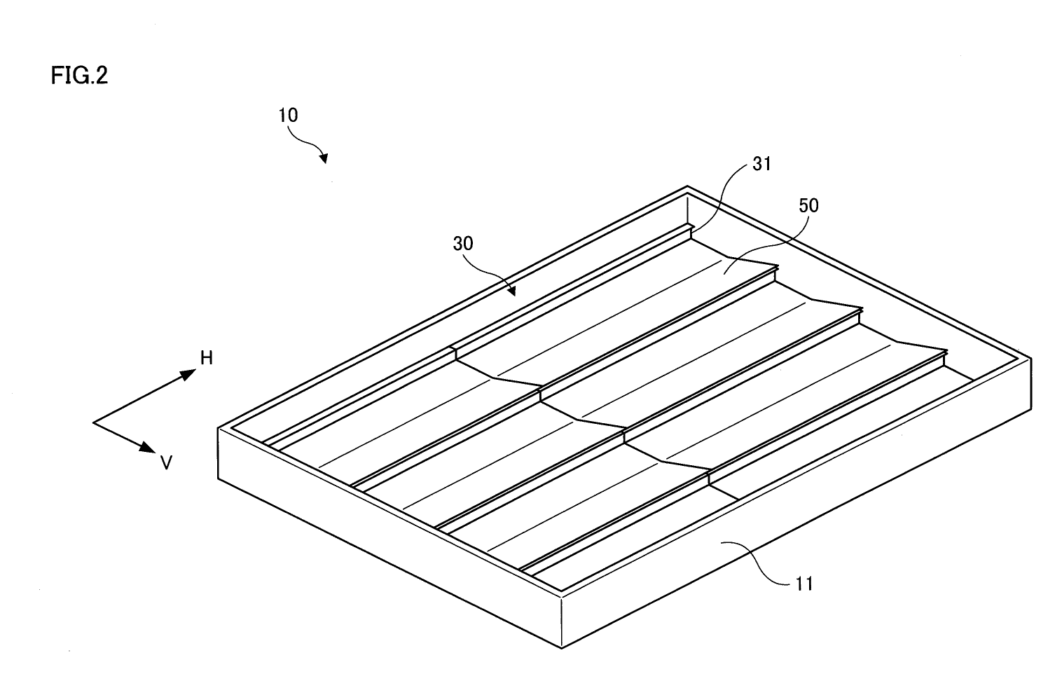

FIGS. 3A to 3D are views for explaining the light source module;

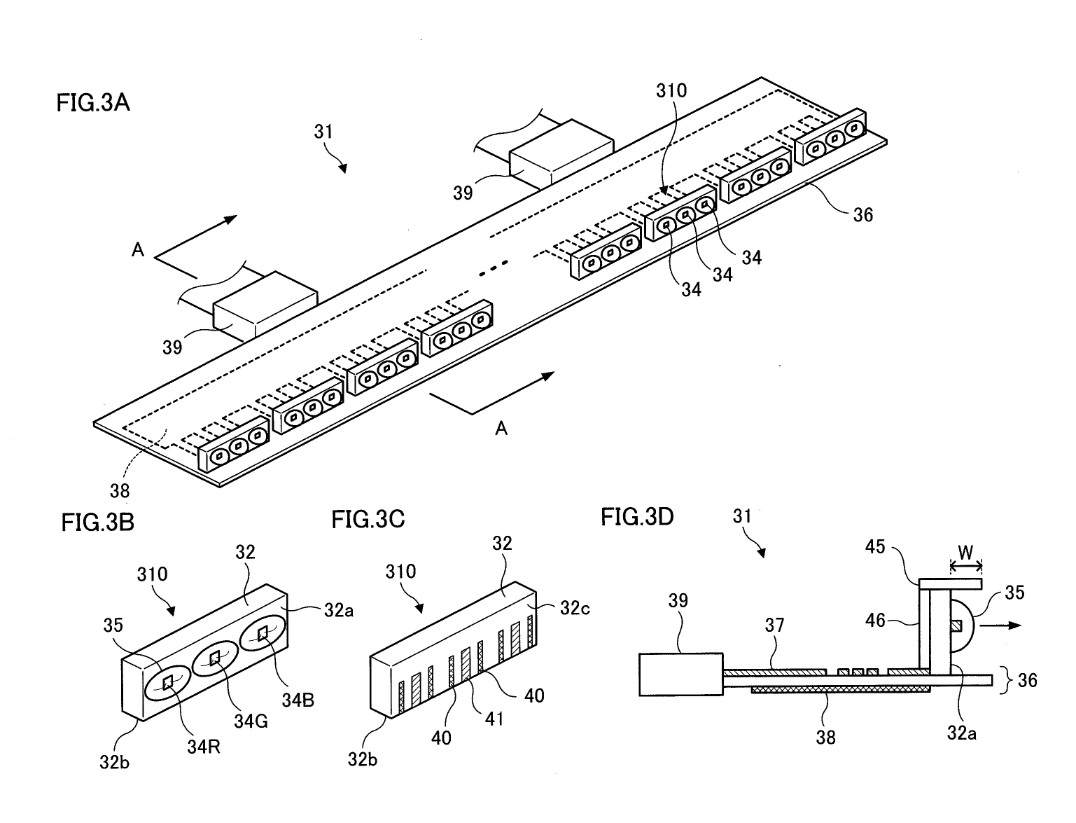

FIG. 4 is a view for explaining the reflector;

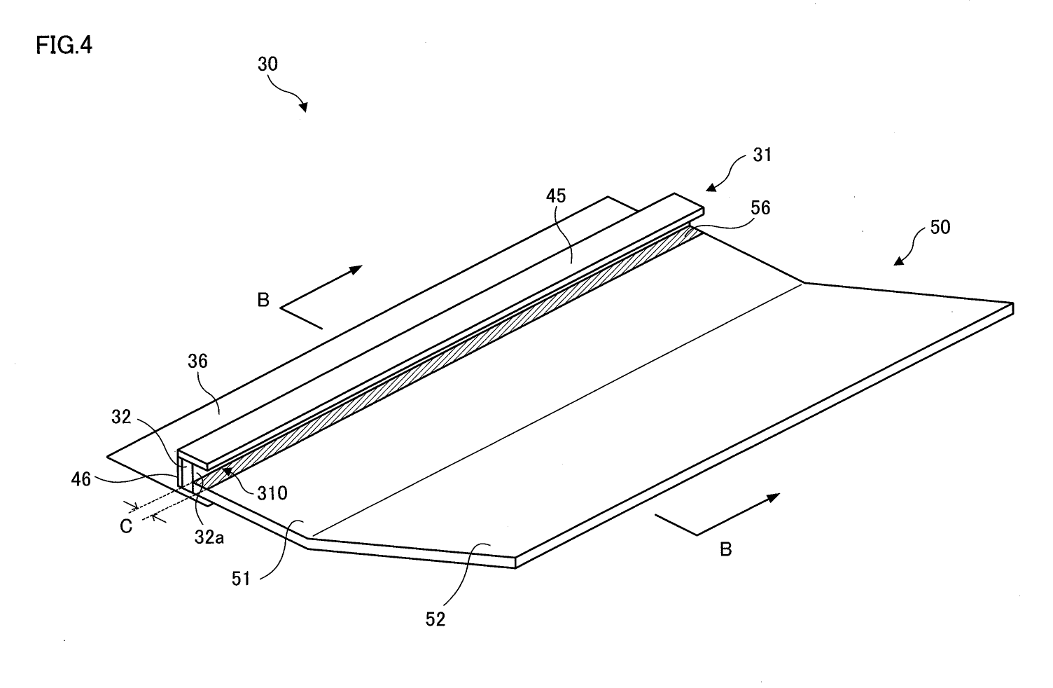

FIGS. 5A and 5B are views for explaining a horizontal reflection portion and a slant reflection portion; and

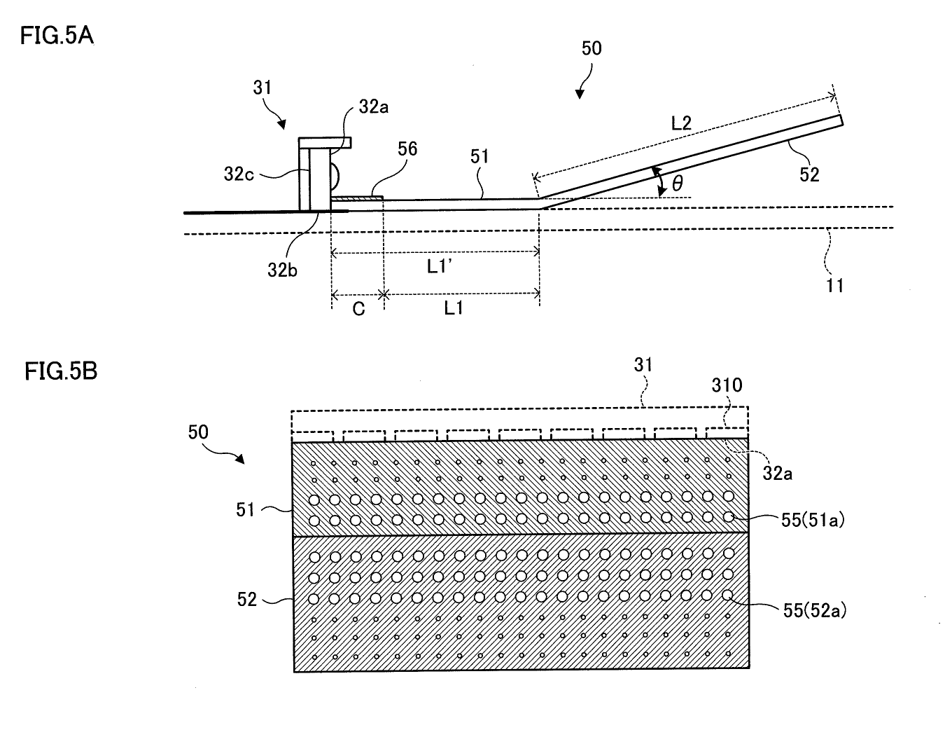

FIG. 6 is a view for explaining a state in which the multiple light emitting units are attached to the backlight frame.

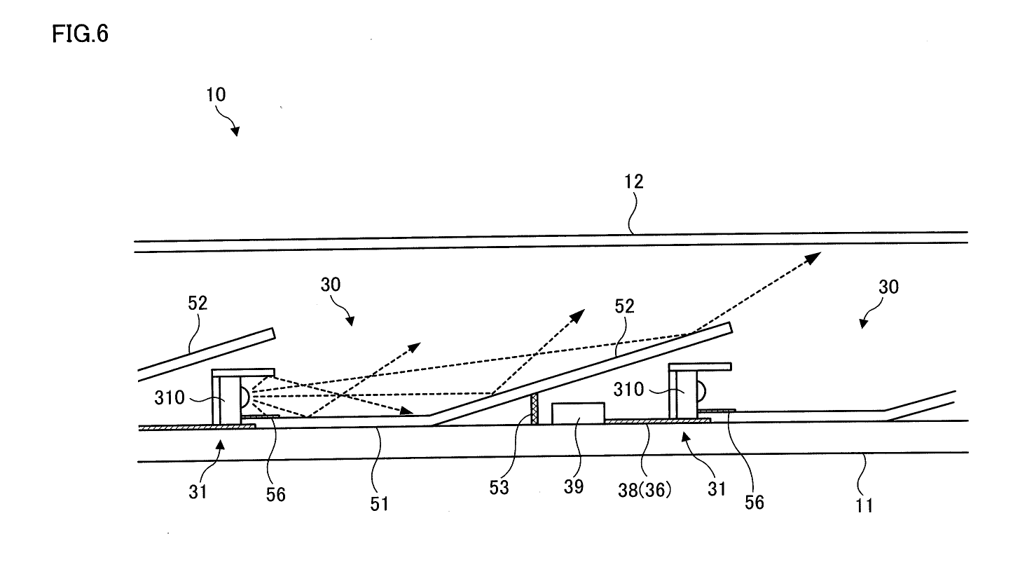

### DESCRIPTION OF REFERENCE NUMERALS AND SIGNS

10 . . . backlight device
11 . . . backlight frame
12 . . . diffusion plate
20 . . . liquid crystal display module
21 . . . liquid crystal panel
30 . . . light emitting unit
31 . . . light source module
310 . . . light emitting portion
32 . . . plate-shaped board
34 . . . LED
36 . . . wiring board
37 . . . electrical wiring pattern
38 . . . heat discharge pattern
39 . . . connector
45 . . . shield member
50 . . . reflector
51 . . . horizontal reflection portion
52 . . . slant reflection portion

1. A display device comprising:
a display panel that displays an image; and
a light emitting device that includes one or a plurality of light emitting units, that is provided behind the display panel, and that emits light from behind the display panel, wherein
each of the light emitting units includes:
a plurality of solid-state light emitting elements;
a shield portion formed to extend in a direction parallel to a principal surface of the display panel, at the display panel side of the plurality of solid-state light emitting elements;
a first reflection portion that is extended in the direction parallel to the principal surface of the display panel, at an opposite side of the plurality of solid-state light emitting elements from the display panel, and that reflects light emitted from any of the plurality of solid-state light emitting elements; and
a second reflection portion that is extended toward the display panel while having a predetermined angle with respect to the first reflection portion, and that reflects light emitted from any of the plurality of solid-state light emitting elements.

2. The display device according to claim 1, wherein in a case where the plurality of light emitting units are provided, the plurality of light emitting units are arrayed adjacent to each other.

3. The display device according to claim 2, wherein the plurality of solid-state light emitting elements provided to one of the light emitting units among the plurality of light emitting units arrayed adjacent to each other are arranged so as to be placed under the second reflection portion on an opposite side of the second reflection portion from the display panel, the second reflection portion being provided to a different light emitting unit adjacent to the one of the light emitting units.

4. The display device according to claim 1, further comprising:
a mount board on which the plurality of solid-state light emitting elements are mounted; and
a wiring board that is extended in the direction parallel to the principal surface of the display panel, and on which the mount board is arranged in such a manner that the wiring board is electrically connected to the mount board, wherein
the mount board has a first surface on which the plurality of solid-state light emitting elements are mounted, and is attached to the wiring board in such a manner that a second surface of the mount board is placed on the wiring board side, the second surface being orthogonal to the first surface.

5. The display device according to claim 4, further comprising a connector that is electrically connected to the wiring board and that supplies power to the plurality of solid-state light emitting elements, wherein
the connector is provided so as to be placed under the second reflection portion on an opposite side of the second reflection portion from the display panel.

6. A light emitting device including a plurality of solid-state light emitting elements arrayed on a plane, the light emitting device comprising:
a frame having a plane portion;
a board on which any of the plurality of solid-state light emitting elements are arrayed in a line;
a shield portion formed to extend in a direction parallel to the plane portion of the frame, at an opposite side of the solid-state light emitting elements arrayed on the board from the frame;
a first reflection portion that is extended in the direction parallel to the plane portion of the frame, at the frame side of the solid-state light emitting elements, and that reflects light emitted from the solid-state light emitting elements arrayed on the board; and
a second reflection portion that is extended while having a predetermined angle with respect to the first reflection portion, and that reflects light emitted from the solid-state light emitting elements arrayed on the board.

7. The light emitting device according to claim 6, wherein the predetermined angle is not less than 10 degrees but not more than 20 degrees.

8. The light emitting device according to claim 6, wherein
the first reflection portion includes:
a first regular reflection portion that regularly reflects light from the solid-state light emitting elements; and
a first diffusion-reflection portion that is formed to have a larger area at a position farther from the solid-state light emitting elements, and that diffusively reflects light from the solid-state light emitting elements, and
the second reflection portion includes:
a second regular reflection portion that regularly reflects light from the solid-state light emitting elements; and
a second diffusion-reflection portion that is formed to have a smaller area at a position farther from the solid-state light emitting elements, and that diffusively reflects light from the solid-state light emitting elements.

9. The light emitting device according to claim 6, further comprising an absorbing member that is provided on the solid-state light emitting elements side of the first reflection portion, and that absorbs part of light from the solid-state light emitting elements.
